(19) United States
(12) Patent Application Publication
(10) Pub. No.: US 2026/0317989 A1
(43) Pub. Date: Oct. 15, 2026

(54) Multi-Function Garment Treatment Device

(71) Applicant: Ultrasonic Technology Solutions, Knoxville, TN (US)

(72) Inventors: Ayyoub Mehdizadeh Momen, Knoxville, TN (US); Connor Jerric Shelander, Knoxville, TN (US); Dennis Boris Chertkovsky, Knoxville, TN (US)

(21) Appl. No.: 19/648,942

(22) Filed: Apr. 15, 2026

Related U.S. Application Data
(60) Provisional application No. 63/789,217, filed on Apr. 15, 2025.

(51) Int. Cl. D06F 58/10; A47G 25/44; B05B 17/06; D06F 58/20; D06F 73/02

(52) U.S. Cl. CPC D06F 58/10; A47G 25/44; B05B 17/06; D06F 58/203; D06F 73/02

(57) ABSTRACT

A portable multi-function device for treating garments comprising a sealed liquid storage component, an ultrasonic mist generator, a garment positioning component with adjustable features, a digital control interface with customizable settings, and a power supply offering both rechargeable battery and wall outlet options. The device delivers treatment liquids as a fine mist to garments positioned within an integrated hanger or enclosure bag, enabling deodorizing, disinfecting, refreshing, and de-wrinkling functions. Optional airflow fans and heating elements accelerate evaporation and drying. The control interface allows users to adjust misting intervals, spray duration, and treatment modes. The system is designed for portable travel use by business travelers and healthcare professionals requiring efficient garment maintenance without over-saturation of delicate fabrics.

### FIELD OF THE INVENTION

The present invention generally relates to garment care systems and devices. More specifically, the present invention pertains to a multi-function garment treatment device designed for use in deodorizing, de-wrinkling, refreshing, and disinfecting garments. The present invention finds application in both residential and travel contexts, offering a portable, efficient, and versatile solution for treating garments without the need for conventional laundering, dry cleaning, or other costly or time-intensive methods.

### BACKGROUND OF THE INVENTION

Consumers often wear certain garments, such as suit coats or work uniforms, multiple times before washing, which leads to the accumulation of odor and bacteria. This issue not only results in an unpleasant experience but also raises hygiene concerns. Specific demographics, including transient business travelers and medical professionals, are frequently impacted by these challenges. Business travelers, due to restrictions on luggage size and space, often carry fewer garments and are compelled to re-use clothing during extended stays. Similarly, medical professionals, such as doctors, typically launder white coats only once every week or two, thereby exposing these garments to bacterial build-up, odors, and other cleanliness issues over time.

Currently available solutions for refreshing garments between washes suffer substantial limitations. While washing or dry cleaning is one option, these methods are cumbersome, expensive, and unsuitable for all fabric types, such as suit coats, which require infrequent dry cleaning to preserve their structure.

Steam treatments, although capable of releasing odors, often fail to replicate the fresh scent and feel achieved through traditional laundering. Fabric refresher sprays deliver some degree of deodorization, but the lack of a convenient and uniform application method diminishes their overall efficacy and ease of use.

More advanced garment care devices, such as the Panasonic Deodorizing Hanger and Whirlpool Swash, employ technologies aimed at odor removal, but these devices are prohibitively expensive, non-portable, and impractical for regular consumer use.

Other advanced systems, such as the LG Styler or Samsung AirDresser, incorporate steam and fragrance-based technologies to reduce odors and wrinkles. However, due to their bulky size, excessive cost, and limited portability, these systems remain unsuitable for individual use cases, particularly in scenarios requiring a mobile or travel-friendly solution. Additionally, the reliance on high-temperature steam in such systems may cause unnecessary wear to delicate fabrics, further restricting their usability.

The limitations of existing solutions present significant challenges to meeting the needs of modern consumers. There is a growing demand for portable and affordable devices that can efficiently refresh, deodorize, de-wrinkle, and disinfect garments.

A practical solution must overcome the high costs, impracticality, and lack of portability associated with current systems while minimizing damage to delicate garments and achieving consistent and effective results. These issues highlight a critical gap in the market for multi-functional garment treatment devices. Thus, there is a significant need to develop a system that addresses these problems by providing a compact, efficient, and affordable solution for deodorizing, disinfecting, de-wrinkling, and refreshing garments. Such a system should be broadly adaptable to different garment types, suitable for use in both residential and travel contexts, and capable of delivering effective treatment without the disadvantages inherent in existing methods.

The present invention is intended to solve the problems associated with conventional devices and methods and provide improvements on these devices.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present invention relates to a "Multi-Function Garment Treatment Device" designed to deliver various liquids to garments for purposes such as refreshment, deodorization, de-wrinkling, or disinfection. The device may vary in shape and size but generally comprises a liquid delivery system, such as a mister, in combination with a fluid reservoir for storing the treatment liquid. Additional components may include a hanger for securely holding garments in place, a garment bag for containing the delivered liquid to enhance treatment efficiency, and optional features such as airflow fans, heating elements, and a control interface. The control interface may incorporate a display screen, such as an OLED, or indicator lights accompanied by nearby control buttons for user customization.

The present invention provides an automated method for delivering treatment liquids to garments in a highly efficient manner without causing significant dampness or damage. The automated delivery system/device enables the uniform application of liquids, such as deodorizing agents or disinfectants, in predetermined intervals, ensuring convenience and portability for the user. This device simplifies and enhances the garment treatment process, making it suitable for both residential and travel use.

### BRIEF DESCRIPTION OF THE DRAWINGS

FIG. 1 illustrates one embodiment of a multi-function garment treatment device with an integrated hanger system, misting mechanism, wireless control connectivity, and portable control interface for remote operation of the garment refreshing and disinfection functions.

FIG. 2 shows one embodiment of a detailed view of the garment hanger component with the internal liquid reservoir, misting mechanism with adjustable nozzles, dual spreading arms, optional airflow fans and heating elements for drying and wrinkle removal, demonstrating the compact internal architecture of the treatment system of the present invention.

FIG. 3 depicts an alternative embodiment featuring a detachable misting mechanism integrated with a vertical garment bag containment system, including external power connections and control interface.

FIG. 4 is an illustration of one embodiment showing an integrated misting mechanism, demonstrating a consolidated single-unit design for standalone operation of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being "preferred" is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more inventions, it is to be understood that this disclosure is illustrative and exemplary of the present invention, and is made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

For example, any sequence(s) and/or temporal order of steps of various processes or methods described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such a term herein. To the extent that the meaning of a term used herein—as understood by the ordinary artisan based on the contextual use of such term—differs in any way from any particular dictionary definition of such a term, it is intended that the meaning of the term as understood by the ordinary artisan should prevail.

Furthermore, it is important to note that, as used herein, "a" and "an" each generally denotes "at least one," but does not exclude a plurality unless the contextual use dictates otherwise. When used herein to join a list of items, "or" denotes "at least one of the items," but does not exclude a plurality of items of the list. Finally, when used herein to join a list of items, "and" denotes "all of the items of the list."

The following detailed disclosure refers to the accompanying drawings and descriptions of the invention. Wherever possible, the same reference numbers are used in the drawings and the detailed description to refer to the same or similar elements. While many embodiments of the disclosure may be described, modifications, adaptations, and other implementations are possible. For instance, substitutions, additions, or modifications may be made to the elements illustrated in the drawings, and the methods described herein may be modified by substituting, reordering, or adding stages to the disclosed methods. Accordingly, the following detailed disclosure does not limit the scope of the invention. Instead, the proper scope of the invention is defined by the claims found herein and/or issuing herefrom. The headers used in the present disclosure are provided for ease of reference and organization and are not to be construed as limiting upon the subject matter disclosed under each header.

The present disclosure includes many aspects and features. Moreover, while many aspects and features relate to, and are described in the context of methods, systems, apparatuses, and devices for a multi-function garment treatment device, embodiments of the present invention are not limited solely to use in this context.

### Overview

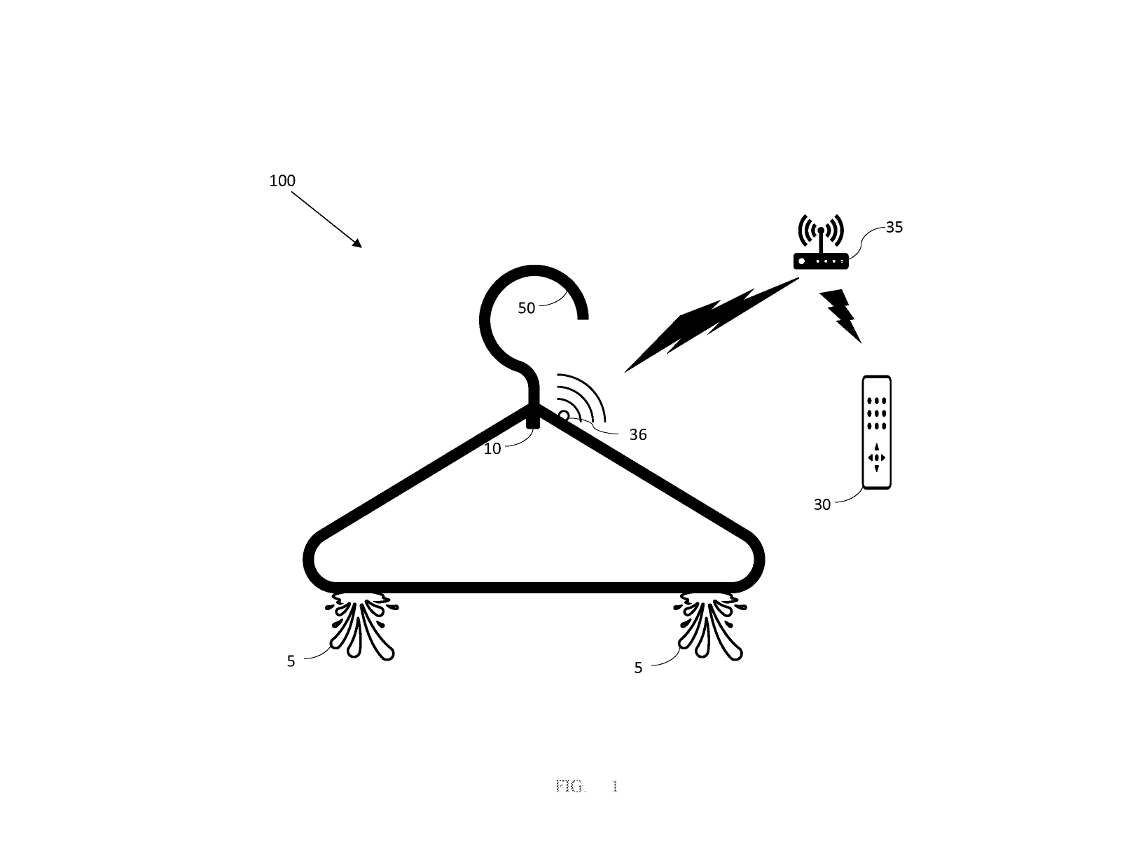

The present invention, as shown in FIGS. 1-4, relates to a multi-function garment treatment device configured to refresh, deodorize, de-wrinkle, and disinfect garments. This compact and portable device incorporates a liquid dispensing system combined with additional functional components, such as garment holders, airflow systems, heating elements, and user control interfaces, to address the limitations of current garment care methods.

Specifically, the device employs a liquid reservoir connected to a misting mechanism capable of delivering liquids in the form of a fine mist for uniform application to garments. By integrating these elements into a unified system, the present invention ensures efficient, hygienic, and cost-effective garment treatment suitable for use in residential and travel settings.

In a preferred embodiment, as shown in FIGS. 1-4, the system/device 100 comprises a liquid reservoir 10, a misting mechanism 25, a garment holder 50 or containment system, airflow and heating elements 40 (optional), and a control interface 30. These components combine to deliver efficient, portable, and versatile garment care, minimizing the shortcomings of existing systems.

### Liquid Reservoir

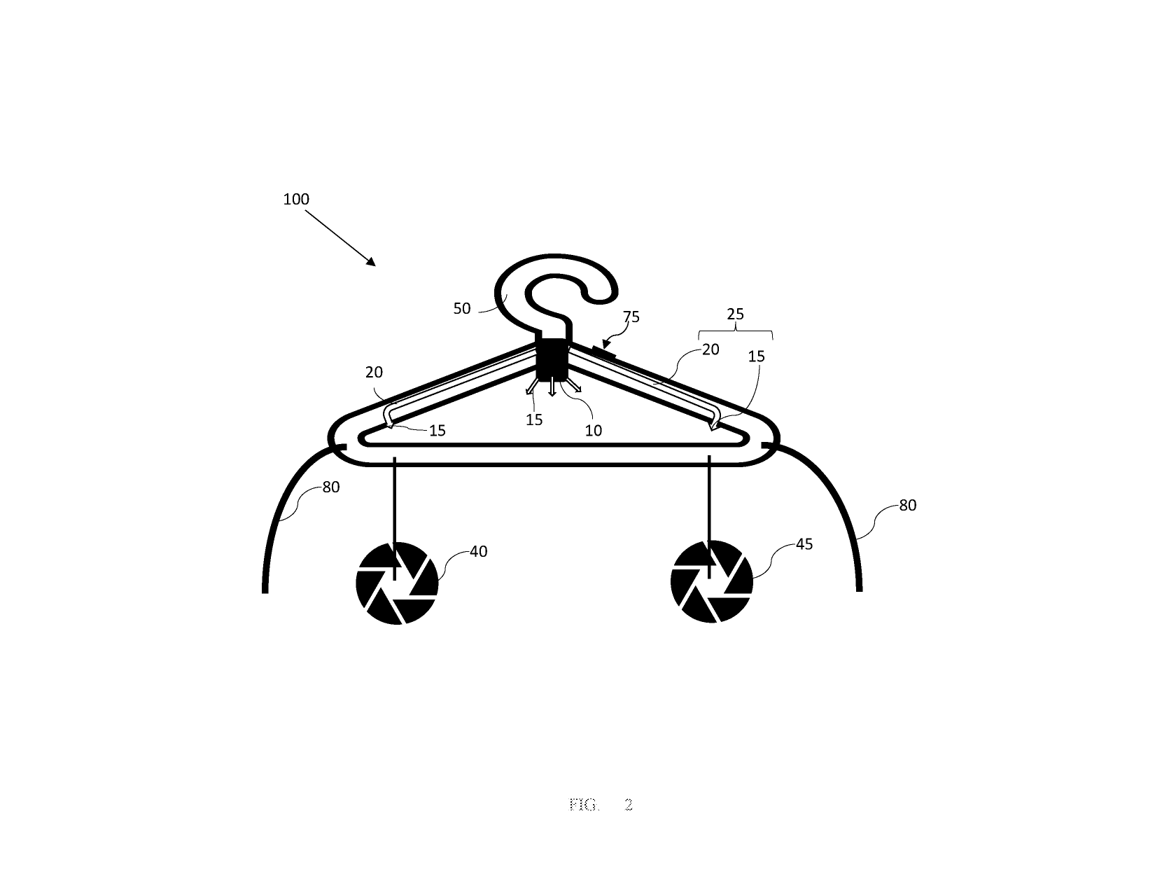

As shown in FIG. 2, the liquid/fluid reservoir 10 is configured to store garment treatment solutions, such as deodorizing agents, refreshing liquids, or disinfectants. The reservoir 10 is connected to a misting mechanism 25 through a sealed delivery channel 20, ensuring consistent liquid flow.

In one embodiment, the reservoir 10 may be a refillable container. Alternatively, it may be designed as a removable or disposable pod, where a puncture mechanism regulates the flow of liquid into the device. These designs ensure flexibility for users, minimizing manual handling of liquids while maintaining efficient fluid delivery.

### Misting Mechanism

As shown in FIG. 2, the misting mechanism 25 (which may include channels 20 and nozzles) converts liquid from the reservoir 10 into a fine mist 5 for uniform application across garment surfaces.

In one embodiment, the device 100 may employ a piezoelectric element based mist generator for efficient atomization. The orientation of the misting nozzle 15 may be adjustable, enabling targeted application to specific garment areas, such as underarms or collars. The misting mechanism ensures precise, controlled release of mist 5 to avoid over-saturation of fabrics, maintaining garment integrity and ensuring effective treatment.

### Garment Holder or Containment System

The present invention includes a garment holder (or containment system) 50 to securely position garments 60 during treatment.

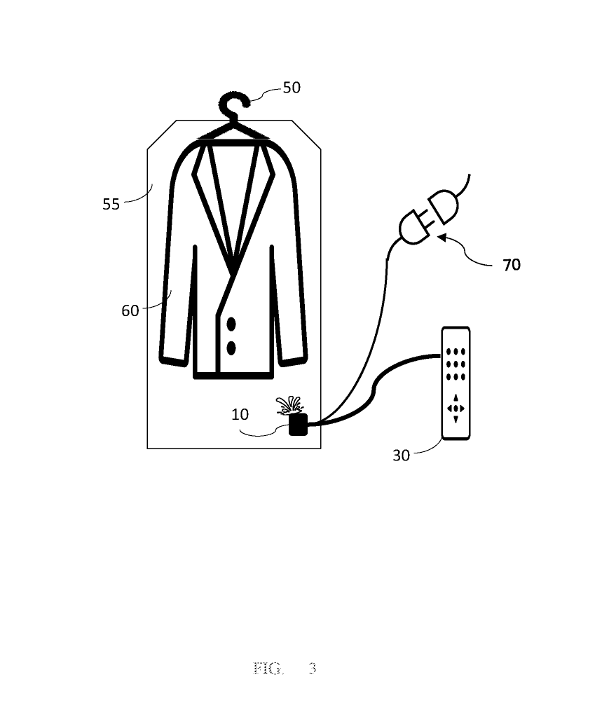

In one implementation, this may take the form of an integrated hanger, as shown in FIGS. 1-4, equipped with hooks or clamps to accommodate various garment types. Alternatively, the system may include a garment bag 55, as shown in FIG. 3, that encloses the garment and misting mechanism, creating a controlled environment to optimize liquid application. This containment prevents mist 5 escape and ensures uniform treatment without unintended seepage. Both configurations prioritize convenience and effective use, adapting to different garment types and user preferences.

### Airflow Fans and Heating Elements Optional

As shown in FIG. 2, the system may include optional airflow fans 40 and heating elements 45 to enhance drying and wrinkle removal. Airflow fans are positioned to direct air onto the garment 60, accelerating the evaporation of treatment liquids.

Heating elements 45 may further aid wrinkle removal and drying, making the system suitable for overnight or extended treatment cycles. Both components integrate seamlessly with the misting process, allowing efficient treatment of garments requiring additional care.

### Control Interface

The control interface 30 provides users with the ability to operate and customize the device. This interface may include buttons, indicator lights, or digital displays, allowing users to adjust misting intervals, spray duration, and drying or heating parameters.

In some embodiments, the interface 30 is electronically connected to the device's core components, such as the misting mechanism 25, reservoir 10, fans 40, and heating elements 45, enabling synchronized operation. The integration of these controls ensures user-friendly and precise functionality for a variety of garment care needs.

In some embodiments, the interface 30 is wirelessly connected to the device's core components via a server 35 and wireless communication device installed on the garment holder 50 or garment bag 55, as shown in FIG. 1.

### Power Supply

The device may be powered by either rechargeable batteries 75 or a direct connection to a wall outlet 70, as shown in FIGS. 2-3, accommodating both portable and stationary use cases. A central wiring board distributes power from the supply to the misting mechanism, control interface, and optional components, ensuring efficient and safe operation of all integrated systems.

### Fabric Spreader

In some embodiments, the device disclosed herein may comprise features configured to spread or open garments, thereby enabling efficient delivery of mist generated by the misting mechanism 25 to target interior areas. In such embodiments, the device may include a set of adjustable arms 80 designed to facilitate the spreading of the garment. In other embodiments, the form factor of the device may be configured to enable the opening of the garment, providing access to interior regions that might otherwise be obstructed.

### Benefits and Applications

The present invention offers significant benefits as compared to existing garment care methods. Its compact and portable design addresses the needs of both residential and mobile users, such as business travelers or professionals dealing with hygiene-sensitive garments. The device delivers treatment liquids as a fine mist in controlled intervals, which eliminates odors, refreshes garments, and removes wrinkles without over-saturating or damaging fabrics. By eliminating the need for costly dry cleaning or frequent laundering, the invention is not only more economical but also provides a time-efficient solution for sustained garment care. Furthermore, added disinfection capabilities ensure hygiene while addressing consumer demands for versatile and effective garment care.

One example involves a business traveler carrying a limited number of garments to minimize luggage size. After a day of wearing a suit coat, the user places the garment within the device's containment system and activates the misting process. Overnight, the device refreshes and deodorizes the garment, enabling the user to wear it odor-free the following day without requiring professional cleaning services.

Another use case involves a healthcare worker treating a lab coat or scrubs after exposure to contaminants. By selecting the disinfection mode, the worker can rely on the device to sanitize and refresh garments using an antibacterial liquid solution. This method eliminates hygiene risks while maintaining garment integrity over repeated uses.

### Alternative Embodiments and Configurations

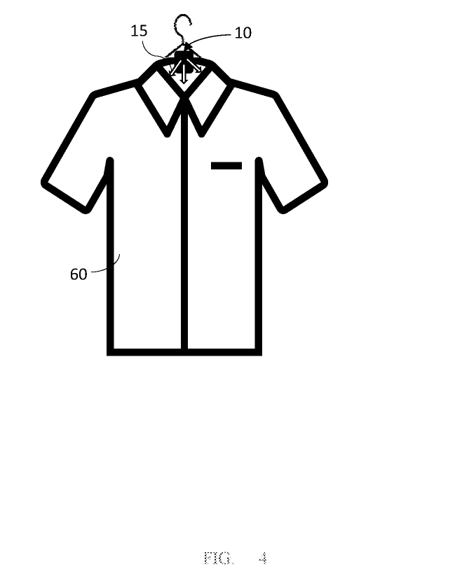

The present invention supports multiple alternative embodiments and configurations to enhance usability. In one embodiment, all components may be integrated into a hanger 50, forming a compact and transportable system, as shown in FIG. 4.

Another implementation includes a detachable misting unit that can clip onto existing garment bags 55, as shown in FIG. 3, making it adaptable to a range of contexts. Disposable liquid pods for deodorizing or disinfecting liquids may replace refillable reservoirs for added convenience. These alternative embodiments ensure the system can adapt to a wide variety of garment care needs and applications.

In another embodiment, the device employs a piezoelectric mister driven by a Class D amplifier with smart resonance-seeking capabilities. The amplifier's high efficiency enables sustained rechargeable battery operation, thereby supporting extended travel use and improving the convenience of the device.

Although the invention has been explained in relation to its preferred embodiment, it is to be understood that many other possible modifications and variations can be made without departing from the spirit and scope of the invention.

What is claimed is:

1. A device for treating garments, comprising:
a liquid storage component configured to attach to a garment holding structure;
a misting component operably connected to the liquid storage component;
a garment positioning component connected to the garment holding structure; and
a control component connected to the liquid storage component.

2. The device of claim 1, wherein the misting component comprises an ultrasonic mist generator.

3. The device of claim 2, wherein the liquid storage component is selected from the group consisting of a refillable container and a disposable pod with a puncture mechanism.

4. The device of claim 2, wherein the garment positioning component comprises an integrated hanger equipped with hooks or clamps.

5. The device of claim 4, wherein the integrated hanger is configured to spread or open garments using adjustable arms for efficient mist delivery to interior areas.

6. The device of claim 1, wherein the garment positioning component comprises a garment bag that encloses the garment and misting component.

7. The device of claim 2, further comprising airflow fans positioned to accelerate evaporation of treatment liquids.

8. The device of claim 7, wherein the airflow fans are controlled via the control component to operate at predetermined intervals.

9. The device of claim 1, further comprising heating elements to aid in wrinkle removal and drying.

10. The device of claim 2, wherein the control component includes buttons, indicator lights, and digital displays for user customization.

11. The device of claim 10, wherein the control component incorporates an OLED display screen.

12. The device of claim 1, further comprising a power component connected to the liquid storage component, the power component comprises rechargeable batteries for portable travel use.

13. The device of claim 12, wherein the power component comprises a power supply offering both a rechargeable battery and a direct wall outlet connection, with a central wiring board distributing power to all operational components.

14. A multi-function garment treatment device system, comprising:
a liquid delivery system including a sealed fluid reservoir with treatment liquid and an ultrasonic mist generator;
a garment containment structure selected from the group consisting of
an integrated hanger with adjustable arms and a garment bag enclosure, wherein the garment containment structure is attached to the liquid delivery system;
a control interface with adjustable parameters for misting intervals, spray duration, heating, and airflow settings, wherein the control interface is connected to the liquid delivery system; and
a misting nozzle with adjustable orientation for targeted application, the misting nozzle is connected to the liquid delivery system.

15. The device system of claim 14, wherein the treatment liquid is selected from the group consisting of deodorizing agents, refreshing liquids, and disinfectants.

16. The device system of claim 14, further comprising a sealed delivery channel between the fluid reservoir and the mist generator ensuring consistent liquid flow without leakage.

17. A method for treating garments, comprising the steps of:
positioning a garment within a containment system;
storing treatment liquid in a sealed reservoir;
converting the treatment liquid into a fine mist via an ultrasonic misting mechanism;
applying the mist to the garment at predetermined intervals via a control interface; and
powering all device components via either rechargeable batteries or a wall outlet connection.

18. The method of claim 17, further comprising the step of drying the garment using airflow fans or heating elements.

19. The method of claim 17, wherein the treatment liquid is applied to eliminate odors, refresh garments, and remove wrinkles without over-saturating delicate fabrics.

20. The method of claim 17, further comprising the step of selecting a disinfection mode to sanitize garments using an antibacterial liquid solution.
